(19) United States
(12) Patent Application Publication
(10) Pub. No.: US 2024/0064729 A1
(43) Pub. Date: Feb. 22, 2024

(54) ENHANCED CROSS-CARRIER SCHEDULING IN FR1-FR2 CARRIER AGGREGATION

(71) Applicant: Telefonaktiebolaget LM Ericsson (publ), Stockholm (SE)

(72) Inventor: Ramy ATAWIA, Kanata (CA)

(21) Appl. No.: 18/260,998

(22) PCT Filed: Jan. 6, 2022
(86) PCT No.: PCT/IB2022/050092

§ 371 Date: Jul. 11, 2023

Related U.S. Application Data
(60) Provisional application No. 63/137,295, filed on Jan. 14, 2021.

(51) Int. Cl. H04W 72/1263; H04W 72/232

(52) U.S. Cl. CPC H04W 72/1263; H04W 72/232

(57) ABSTRACT

A first network node configured to communicate with a second network node and a wireless device (WD) is provided. The first network node comprises processing circuitry configured to determine a cross-carrier scheduling based at least in part on a current load on the first network node. In addition, a signaling is determined based on the determined cross-carrier scheduling. The signaling includes at least a control signal transmitted at least to the WD by the second network node and uplink (UL) data transmitted by the WD to the first network node in response to the control signal. A method implemented in the first network node is provided. A second network node, a WD, and corresponding methods are also provided.

### TECHNICAL FIELD

The present disclosure relates to wireless communications, and in particular, to cross-carrier scheduling in carrier aggregation.

### BACKGROUND

Communication networks, such as those provided based on standards promulgated by the 3rd Generation Partnership Project (3GPP), e.g., Long Term Evolution (LTE) and New Radio (NR) (NR is also referred to as 5G), generally benefit from carrier aggregation (CA). In particular, CA may include at least a Primary Cell (PCell) and a Secondary Cell (SCell). Difficulties associated with CA communication arise when at least one of the cells, i.e., PCell or SCell, becomes congested or channel conditions degrade.

The PCell is typically responsible for scheduling all uplink (UL) data for the SCells, where a SCell is suffering from degraded UL channel conditions, e.g., PCell as NR Frequency Range 1 (FR1) and SCell as NR Frequency Range 2 (FR2). FIG. 1 shows a typical UL scheduling process in inter-band CA, including Physical Downlink Control Channel (PDCCH) transmissions carrying the grant information and Physical Uplink Shared Channel (PUSCH) carrying user data payload.

In recent 3GPP releases, a functionality called cross-carrier scheduling was introduced in which the PCell can transmit indications of UL grants in the PDCCH, while the wireless device (WD) transmits the PUSCH on a SCell. A typical process of 3GPP cross-carrier scheduling in FR1-FR2 carrier aggregation is shown in FIG. 2.

The existing approach described in current 3GPP standards is in line with legacy approaches for LTE, which is problematic at least in cases of FR1-FR2 carrier aggregation. The existing approaches are especially problematic in coverage extension regions due to at least the following:
An FR2 SCell may not have appropriate UL coverages, resulting in the PUSCH not being correctly decoded by the SCell.
Less gain from FR1-FR2 CA as PDCCH demand, especially for SCells traffic, increases when a Special Cell (SpCell) is serving multiple SCells due to: (1) the difference in numerology as FR2 SCells schedule DL much faster than SpCells that are scheduling UL information, e.g., Transmission Control Protocol (TCP) Acknowledgement (ACK) and/or Negative-Acknowledge (NACK); and (2) the limited bandwidth (BW) of FR1 SpCell, especially with Frequency Division Duplex (FDD) cells, a small number of PDCCH symbols will be available for assignments and grants.
No consideration on inter-node, e.g., inter-gNodeB (inter-gNB), links between PCell and SCell where data received from the WD at the PCell might not be decoded, e.g., due to a delayed indicator from SCell to PCell.
Overlooking stringent requirements of some UL signals such as Channel State Information (CSI) reports (from WD to FR1 PCell) which has to be transmitted at a predefined time offset from FR2 SCell Channel State Information Reference Signal (CSI-RS).

### SUMMARY

Some embodiments advantageously provide methods, systems, and apparatuses for cross-carrier scheduling in FR1-FR2 carrier aggregation. According to one aspect of the present disclosure, a first network node configured to communicate with a second network node and a wireless device (WD) is described. The first network node comprising processing circuitry configured to determine a cross-carrier scheduling based at least in part on a first network load on the first network node. In addition, a signaling is determined based on the determined cross-carrier scheduling, the signaling including a control signal transmitted at least to the WD by the second network node and uplink (UL) data transmitted by the WD to the first network node in response to the control signal.

In some embodiments, the processing circuitry is further configured to at least one of determine whether the WD supports the cross-carrier scheduling based on a field of a WD capability message; and configure the WD to decode downlink control information, DCI, in the control signal transmitted by the second network node and at least one of decode downlink (DL) data from the first network and transmit UL data.

In some other embodiments, the processing circuitry is further configured to determine a physical downlink control channel (PDCCH) of the first network node is congested; select the second network node for transmission of the control signal to the WD, where the selection of the second network node is based at least on an inter-network delay between the first and second network nodes and a PDCCH demand of the WD; and determining UL data requirements for communication between the WD and the first network node.

In one embodiment, the processing circuitry is further configured to at least one of determine an alignment time interval based on network variations and an inter-network delay; and after the alignment time interval elapses, align slots and resources in which the second network node transmits the DCI and the first network node one of receives UL data on a PUSCH from the WD and transmits downlink data on a physical downlink shared channel (PDSCH) to the WD.

In another embodiment, the processing circuitry is further configured to, when at least one of the second network node and the WD is not available for the cross-carrier scheduling, at least one of: increase downlink resources of one of the first network node and the second network node; offload the second network node from other WDs to decrease a second network load on the second network node; and modify a UL scheduling process.

In some embodiments, the processing circuitry is further configured to cause the first network node to at least one of: transmit, to the second network node, a request to build and transmit the control signal including a DCI grant to the WD, where the request includes information for building the DCI grant; receive, from the second network node, a confirmation based on the request; receive WD data and update network load information and inter-network delay information based on the received WD data; and transmit, to the second network node, a retransmission request when one of UL data on a physical uplink shared channel (PUSCH), is not decoded and the control signal on PDCCH is not received by the WD.

In some other embodiments, the first network node is a Primary Cell, PCell, operating within a first Frequency Range (FR1) and the second network node is Secondary Cell (SCell) operating within a second Frequency Range (FR2).

According to another aspect, a method implemented in a first network node configured to communicate with a second network node and a wireless device (WD) is described. The method includes determining a cross-carrier scheduling based at least in part on a first network load on the first network node. In addition, a signaling is determined based on the determined cross-carrier scheduling, the signaling including a control signal transmitted at least to the WD by the second network node and uplink (UL) data transmitted by the WD to the first network node in response to the control signal.

In some embodiments, the method further includes at least one of determining whether the WD supports the cross-carrier scheduling based on a field of a WD capability message; and configuring the WD to decode downlink control information, DCI, in the control signal transmitted by the second network node and at least one of decode downlink (DL) data from the first network and transmit UL data.

In some other embodiments, the method further includes determining a physical downlink control channel (PDCCH) of the first network node is congested; select the second network node for transmission of the control signal to the WD, where the selection of the second network node is based at least on an inter-network delay between the first and second network nodes and a PDCCH demand of the WD; and determining UL data requirements for communication between the WD and the first network node.

In one embodiment, the method further includes at least one of determining an alignment time interval based on network variations and an inter-network delay; and after the alignment time interval elapses, aligning slots and resources in which the second network node transmits the DCI and the first network node one of receives UL data on a PUSCH from the WD and transmits downlink data on a physical downlink shared channel (PDSCH) to the WD.

In another embodiment, the method further includes, when at least one of the second network node and the WD is not available for the cross-carrier scheduling, at least one of: increasing downlink resources of one of the first network node and the second network node; offloading the second network node from other WDs to decrease a second network load on the second network node; and modifying a UL scheduling process.

In some embodiments, the method further includes: transmitting, to the second network node, a request to build and transmit the control signal including a DCI grant to the WD, where the request includes information for building the DCI grant; receiving, from the second network node, a confirmation based on the request; receiving WD data and update network load information and inter-network delay information based on the received WD data; and transmitting, to the second network node, a retransmission request when one of UL data on a physical uplink shared channel, PUSCH, is not decoded and the control signal on PDCCH is not received by the WD.

In some other embodiments, the first network node is a Primary Cell, PCell, operating within a first Frequency Range (FR1) and the second network node is Secondary Cell (SCell) operating within a second Frequency Range (FR2).

According to one aspect, a second network node configured to communicate at least with a first network node and a wireless device (WD) is described. The second network node comprises processing circuitry configured to cause the second network node to: receive a signal from the first network node, the signal comprising an indication of cross-carrier scheduling of the WD; and send (e.g., transmit) a control signal to the WD, the control signal including at least one of an uplink grant for transmitting UL data to the first network node and a request to transmit a channel state information (CSI) report to the first network node.

In some embodiments, the processing circuitry is further configured to at least one of at least one of: determine an alignment time interval based on network variations and an inter-network delay; and after the alignment time interval elapses, align slots and resources in which the second network node transmits downlink control information (DCI); and the first network node one of receives the UL data on a PUSCH from the WD and transmits downlink data on a physical downlink shared channel (PDSCH) to the WD.

In some other embodiments, the processing circuitry is further configured to cause the second network node to: receive, from the first network node, a request to build and transmit the control signal including a DCI grant to the WD, the request including information for building the DCI grant; transmit, to the first network node, a confirmation based on the received request; and transmit, to the WD, the control signal.

In one embodiment, the processing circuitry is further configured to cause the second network node to receive, from the first network node, a retransmission request associated with at least one of UL data on a physical uplink shared channel (PUSCH) not being decoded by the first network node and the control signal not being received by the WD; and retransmit the control signal to the WD and including one of a UL scheduling information, an elevated PDCCH aggregation level, and an elevated power level.

In another embodiment, the processing circuitry is further configured to cause the second network node to transmit, to a third network node, the control signal including the DCI grant indicating a physical uplink shared channel, PUSCH, grant.

In some embodiments, the processing circuitry is further configured to, after receiving the request to build and transmit the control signal, determine an amount of PDCCH resources to serve the WD based at least one of a current downlink, DL, channel conditions and a traffic load.

In one embodiment, the processing circuitry is further configured to determine a DCI associated with DL data scheduling, the DCI to be transmitted by the second network node to the WD.

In another embodiment, the first network node is a Primary Cell, PCell, operating within a first Frequency Range (FR1) and the second network node is Secondary Cell (SCell) operating within a second Frequency Range (FR2).

According to another aspect, a method implemented in a second network node configured to communicate at least with a first network node and a wireless device is described. The method comprises receiving a signal from the first network node, the signal comprising an indication of cross-carrier scheduling of the WD. The method further includes sending (e.g., transmitting) a control signal to the WD, the control signal including at least one of an uplink grant for transmitting UL data to the first network node and a request to transmit a channel state information (CSI) report to the first network node.

In some embodiments, the method further includes at least one of: determining an alignment time interval based on network variations and an inter-network delay; and after the alignment time interval elapses, aligning slots and resources in which the second network node transmits downlink control information (DCI); and the first network node one of receives the UL data on a PUSCH from the WD and transmits downlink data on a physical downlink shared channel (PDSCH) to the WD.

In some other embodiments, the method further includes receiving, from the first network node, a request to build and transmit the control signal including a DCI grant to the WD, the request including information for building the DCI grant; transmitting, to the first network node, a confirmation based on the received request; and transmitting, to the WD, the control signal.

In one embodiment, the method further includes receiving, from the first network node, a retransmission request associated with at least one of UL data on a physical uplink shared channel (PUSCH) not being decoded by the first network node and the control signal not being received by the WD; and retransmitting the control signal to the WD and including one of a UL scheduling information, an elevated PDCCH aggregation level, and an elevated power level.

In another embodiment, the method further includes transmitting, to a third network node, the control signal including the DCI grant indicating a physical uplink shared channel, PUSCH, grant.

In some embodiments, the method further includes, after receiving the request to build and transmit the control signal, determining an amount of PDCCH resources to serve the WD based at least one of a current downlink, DL, channel conditions and a traffic load.

In one embodiment, the method further includes determining a DCI associated with DL data scheduling, the DCI to be transmitted by the second network node to the WD.

In another embodiment, the first network node is a Primary Cell, PCell, operating within a first Frequency Range (FR1) and the second network node is Secondary Cell (SCell) operating within a second Frequency Range (FR2).

According to one aspect, a wireless device (WD) configured to communicate at least with a first network node and a second network node is described. The first network node is a Primary Cell (PCell) operating within a first Frequency Range (FR1), and the second network node is a Secondary Cell, (Scell) operating within a second Frequency Range (FR2). The WD includes processing circuitry configured to cause the WD to receive a control signal transmitted by the second network node and transmit WD data including uplink (UL) data to the first network node in response to the received control signal.

In some embodiments, the control signal includes a downlink control information (DCI) grant for the UL data to be transmitted to the first network node.

In some other embodiments, the processing circuitry is further configured to cause WD to transmit a message indicating the WD supports communication with the first network node and the second network node using cross-carrier scheduling.

In one embodiment, the processing circuitry is further configured to cause WD to, after an alignment time interval elapses, receive aligned slots and resources in which the second network node transmits the DCI and the first network node one of receives the UL data on a physical uplink shared channel (PUSCH) from the WD and transmits downlink data on a physical downlink shared channel (PDSCH) to the WD.

In another embodiment, the processing circuitry is further configured to cause WD to receive a retransmission of the control signal from the second network node, the retransmission including the DCI grant and including one of a new uplink, UL, scheduling information, an elevated physical downlink control channel (PDCCH) aggregation level, and an elevated power level.

In some embodiments, the processing circuitry is further configured to cause WD to, when one of the second network node and the WD is not available for cross-carrier scheduling, at least one of: receive increased downlink resources of one of the first network node and the second network node; receive an offload message to offload from the second network node; and receive a modified UL scheduling.

According to another aspect, a method implemented in a wireless device (WD) configured to communicate at least with a first network node and a second network node is described. The first network node is a Primary Cell (PCell) operating within a first Frequency Range (FR1), and the second network node is a Secondary Cell, (Scell) operating within a second Frequency Range (FR2). The method includes receiving a control signal transmitted by the second network node and transmitting WD data including uplink to the first network node in response to the received control signal.

In some embodiments, the control signal includes a downlink control information (DCI) grant for the UL data to be transmitted to the first network node.

In some other embodiments, the method further includes transmitting a message indicating the WD supports communication with the first network node and the second network node using cross-carrier scheduling.

In one embodiment, the method further includes, after an alignment time interval elapses, receiving aligned slots and resources in which the second network node transmits the DCI and the first network node one of receives the UL data on a physical uplink shared channel (PUSCH) from the WD and transmits downlink data on a physical downlink shared channel (PDSCH) to the WD.

In another embodiment, the method further includes receiving a retransmission of the control signal from the second network node, the retransmission including the DCI grant and including one of a new uplink, UL, scheduling information, an elevated physical downlink control channel (PDCCH) aggregation level, and an elevated power level.

In some embodiments, the method further includes, when one of the second network node and the WD is not available for cross-carrier scheduling, at least one of: receiving increased downlink resources of one of the first network node and the second network node; receiving an offload message to offload from the second network node; and receiving a modified UL scheduling.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a signal diagram of a typical UL scheduling process in an inter-band carrier aggregation environment;

FIG. 2 is a signal diagram of a typical cross-carrier scheduling process in an FR1-FR2 carrier aggregation environment;

FIG. 3 is a schematic diagram of an example network architecture illustrating a communication system connected via an intermediate network to a host computer according to the principles in the present disclosure;

FIG. 4 is a block diagram of a host computer communicating via at least a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example method in a first network node for cross-carrier scheduling according to some embodiments of the present disclosure;

FIG. 10 is a flowchart of an example method in a second network node for cross-carrier scheduling according to some embodiments of the present disclosure;

FIG. 11 is a flowchart of an example method in a wireless device for cross-carrier scheduling according to some embodiments of the present disclosure;

FIG. 12 is a flowchart of another example method in a first network node for cross-carrier scheduling according to some embodiments of the present disclosure;

FIG. 13 is a flowchart of another example method in a second network node for cross-carrier scheduling according to some embodiments of the present disclosure;

FIG. 14 is a flowchart of another example method in a wireless device for cross-carrier scheduling according to some embodiments of the present disclosure;

FIG. 15 is a signal diagram of an example process for cross-carrier scheduling where a second network node, e.g., SCell FR2, transmits DCI and a WD transmits data to a first network node, e.g., PCell FR1, according to some embodiments of the present disclosure;

FIG. 16 is a signal diagram of an example process where a first network node, e.g., a PCell, selects and coordinates with a second network node, e.g., a SCell, for cross carrier scheduling with DCI grant from the second network node according to some embodiments of the present disclosure;

FIG. 17 is a flowchart of an example process in a first network node for cross-carrier UL scheduling based on coordination between a first network node and second network node, e.g., PCell-SCell, inter-gNB, according to some embodiments of the present disclosure;

FIG. 18 is a flowchart of an example process in a second network node for cross-carrier UL scheduling based on coordination between a first network node and second network node, e.g., PCell-SCell, inter-gNB, according to some embodiments of the present disclosure;

FIG. 19 is a flowchart of an example process in a first network node for cross-carrier UL scheduling based on coordination between a first network node and second network node, e.g., PCell-SCell, inter-gNB, according to some embodiments of the present disclosure;

FIG. 20 is a flowchart of another example process in a second network node for cross-carrier UL scheduling based on coordination between a first network node and second network node, e.g., PCell-SCell, inter-gNB, according to some embodiments of the present disclosure; and

FIG. 21 is a flowchart of an example process for reserved UL allocation based on a delay between network nodes, e.g., an inter-gNB delay, according to some embodiments of the present disclosure.

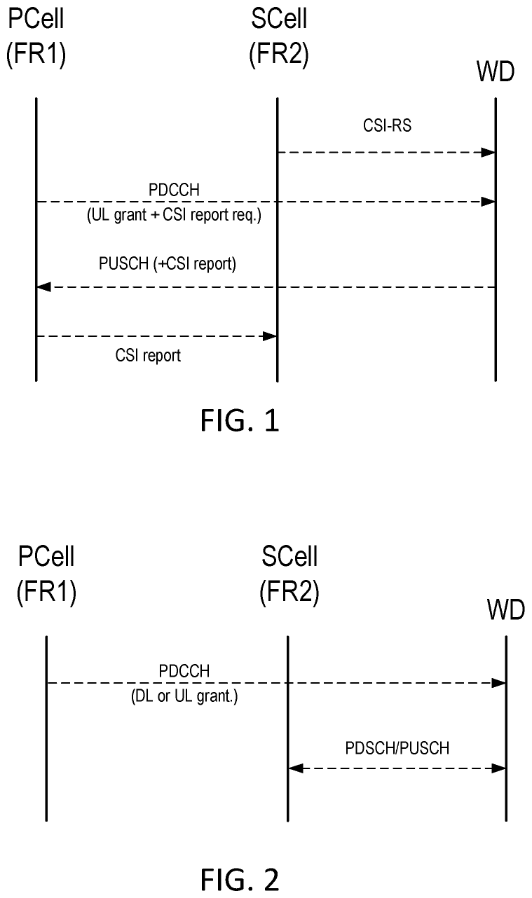

### DETAILED DESCRIPTION

In some embodiments, a cross-carrier scheduling process is provided between FR1 and FR2, where a FR2 SCell sends control channels, e.g., due to large available BW at FR2, while the FR1 PCell receives UL data from the WD, e.g., due to proper UL coverage at FR1. In some other embodiments, DL data from PCell using DCI from SCell may be provided.

The process firstly assesses control channel resources on FR1 PCell to serve the SCell WDs, and then configures both cells and WDs with the cross-carrier scheduling, taking into account: (1) WD capabilities; (2) inter-gNB delay for PCell-SCell coordination; (3) UL traffic requirements, e.g., CSI report allowed delay; and (4) SCell load and user priorities.

The process aims to provide backward compatibility by switching between possible UL scheduling techniques based on system load and WD capabilities, as well as by reconfiguring PCell and SCell. In addition, the cross-carrier scheduling process of the present disclosure: (1) ensures proper carrier aggregation gain between FR1-FR2 NR cells when control channels for UL/DL scheduling become a bottleneck at FR1 PCell; (2) ensures proper contention on FR1 PCell control channel resources between CA and non-CA users, thereby yielding performance gains for non-CA WDs; (3) Ensures correct decoding of UL/DL data for CA users by coordination between non-collocated FR1 PCell and FR2 SCells; and (4) ensures backward compatibility with existing techniques to solve control channel contention problems.

In some other embodiments, a new scheme for FR2 SCells scheduling DCI for PCell UL/DL data reception/transmission is provided. The PCell is capable of identifying compatible WDs based on capability signaling, and performance of CA WDs is adjusted by offloading DCI transmissions from FR1 PCell to FR2 SCells based on the PDCCH demand, capacity on each cell, and WD capability.

Coordination between PCell and SCell is provided for reliable DCI and shared channel scheduling while taking into account inter-gNB delay and WD feedback. In addition, PCell and SCell configurations may be changed to leverage cross-carrier scheduling and/or switching between different UL scheduling algorithms can be provided.

Before describing in detail example embodiments, it is noted that the embodiments reside primarily in combinations of apparatus components and processing steps related to cross-carrier scheduling in carrier aggregation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide cross-carrier scheduling in carrier aggregation communication where at least a wireless device communicates with a first network node, e.g., a PCell, that operates within a first frequency range, e.g., FR1, and with a second network node, e.g., SCell, that operates in a second frequency range, FR2.

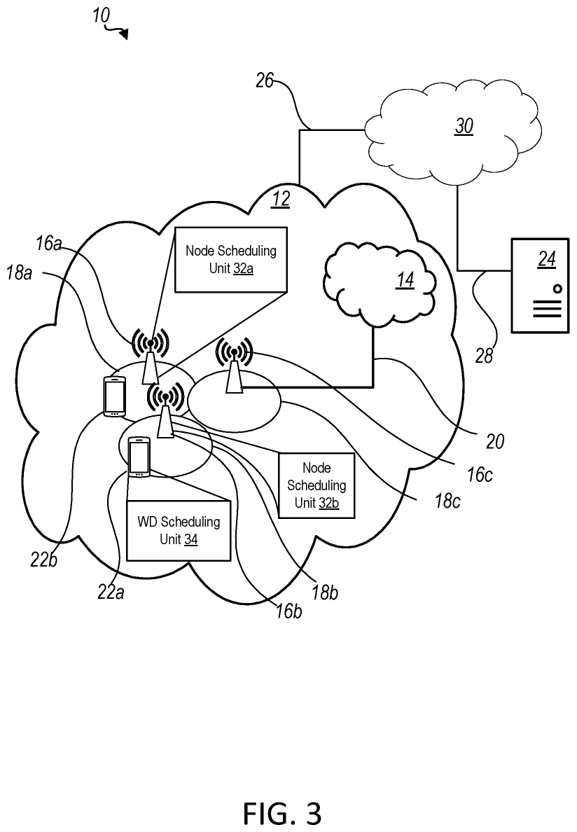

Referring now to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NB s, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16a is configured to include a node scheduling unit 32a which is configured to provide cross-carrier scheduling in carrier aggregation. Similarly, a network node 16b is configured to include a node scheduling unit 32b configured to provide cross-carrier scheduling in carrier aggregation. Node scheduling units 32a and 32b may be referred to collectively as node scheduling unit 32. Other network nodes 16c, 16d, 16e, etc., may be provided and may be configured to provide at least cross-carrier scheduling in carrier aggregation as provided by network nodes 16a and 16b. A wireless device 22 is configured to include a WD scheduling unit 34 which is configured to communicate at least with the network nodes 16 using cross-carrier scheduling in carrier aggregation.

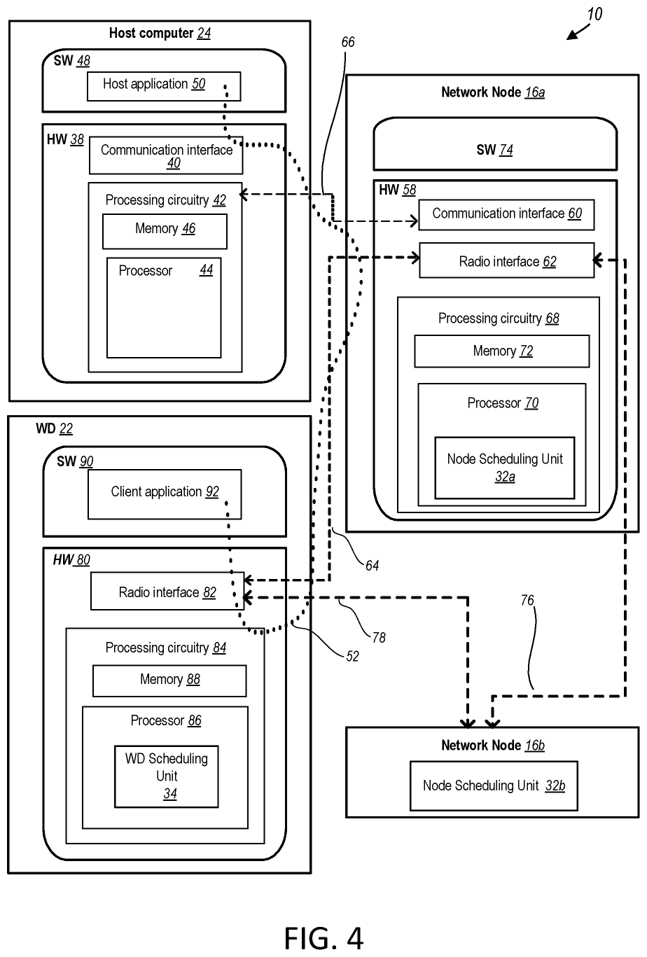

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24. Processing circuitry 42 may cause host computer 24 and/or communication interface 40 to perform any process/method/step/feature described in the present disclosure, e.g., transmit and/or receive such as transmit and/or receive any signal, message, information, data, etc.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22.

The communication system 10 further includes a network node 16a provided in a communication system 10 and including hardware 58 enabling it to communicate with network node 16b, the host computer 24, and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16a and/or 16b. Radio interface 62 may be also be included for setting up and maintaining wireless communication 76 with network node 16b. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16a further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Processing circuitry 68 may cause network node 16 and/or communication interface 60 and/or radio interface 62 to perform any process/method/step/feature described in the present disclosure, e.g., transmit and/or receive such as transmit and/or receive any signal, message, information, data, etc.

Thus, the network node 16a further has software 74 stored internally in, for example, memory 72, or stored in external memory (e.g., database, storage array, network storage device, etc.) accessible by the network node 16a via an external connection. The software 74 may be executable by the processing circuitry 68. The processing circuitry 68 may be configured to control any of the methods and/or processes described herein and/or to cause such methods, and/or processes to be performed, e.g., by network node 16a and/or 16b. Processor 70 corresponds to one or more processors 70 for performing network node 16a functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16a. For example, processing circuitry 68 of the network node 16a may include node scheduling unit 32a configured to provide cross-carrier scheduling in carrier aggregation.

The communication system 10 further includes network node 16b configured to include the same or similar components described above and included in network node 16a. In addition, network node 16a is configured to perform and provide the same processes performed by network node 16a. For example, network node 16b may include node scheduling unit 32b configured to perform the same or similar methods and/or processes as node scheduling unit 32a in network node 16. Further, network node 16b may be configured for setting up and maintaining at least a wireless connection 78 with a WD 22 located in a coverage area 18 served by the network node 16a and/or 16b.

The communication system 10 further includes the WD 22 already referred to. The WD 22 may have hardware 80 that may include a radio interface 82 configured to set up and maintain wireless connections 64, 78 with a network node 16a, 16b serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Processing circuitry 84 may cause WD 22 and/or radio interface 82 to perform any process/method/step/feature described in the present disclosure, e.g., transmit and/or receive such as transmit and/or receive any signal, message, information, data, etc.

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD scheduling unit 34 configured to communicate at least with the network nodes 16 using cross-carrier scheduling in carrier aggregation.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connections 64, 78 between the WD 22 and network nodes 16a, 16b are in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as node scheduling unit 32 and WD scheduling unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

It is also contemplated that PCell and SCell may both be or be formed by network nodes 16. In a non-limiting example, a PCell may be a network node 16a, and a SCell may be a network node 16b. Similarly, a Primary SCell (PSCell) and a SpCell may also be network nodes 16, e.g., PSCell may be a network node 16c, and SpCell may be a network node 16d. However, the network node 16 is not limited to the types of cells or to the order of cells described above and may be any type of cell in any order.

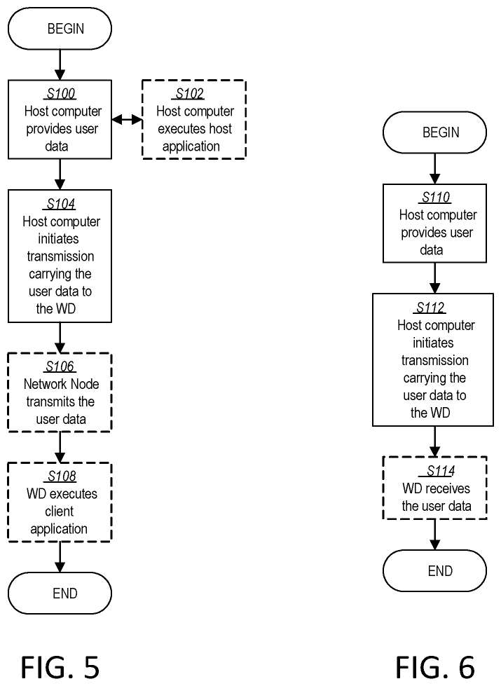

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

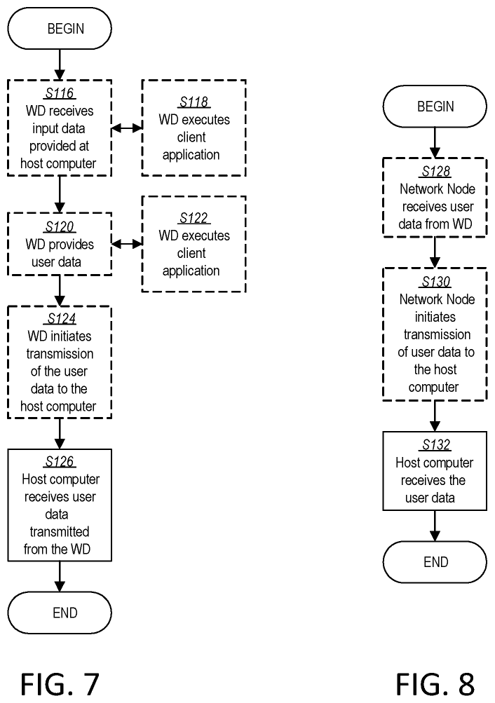

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

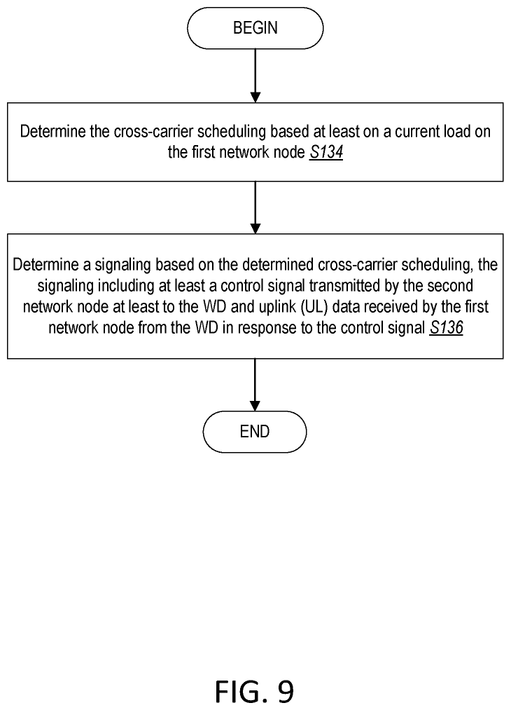

FIG. 9 is a flowchart of an example method in a first network node 16a, e.g., PCell, for cross-carrier scheduling according to some embodiments of the present disclosure. One or more blocks described herein may be performed by one or more elements of network node 16a such as by one or more of processing circuitry 68 (including the node scheduling unit 32a), processor 70, radio interface 62 and/or communication interface 60. The method includes determining (Block S134), such as via processing circuitry 68 and/or processor 70 and/or radio interface 62 and/or communication interface 60, the cross-carrier scheduling based at least on a current load on the first network node 16a. In addition, a signaling is determined (Block S136), such as via processing circuitry 68 and/or processor 70 and/or radio interface 62 and/or communication interface 60, based on the determined cross-carrier scheduling. The signaling includes at least a control signal transmitted by the second network node 16b at least to the WD 22 and uplink (UL) data received by the first network node 16a from the WD 22 in response to the control signal.

In some embodiments, the method includes determining whether the WD 22 supports the cross-carrier scheduling based on a field of a WD capability message. In addition, the method includes configuring the WD 22 to decode a downlink control information (DCI) in the control signal transmitted by the second network node 16b and to one of transmit the UL data and decode downlink (DL) data from the first network node. In some other embodiments, the first network node 16a is a Primary Cell (PCell) operating within a first Frequency Range (FR1) and the second network node 16b is Secondary Cell (SCell) operating within a second Frequency Range (FR2).

In another embodiment, the method includes determining a physical downlink control channel (PDCCH) of the first network node 16a is congested. The second network node 16b is selected for transmission of the signaling including at least the control signal transmitted by the second network node 16b at least to the WD 22 and the UL data received by the first network node 16a from the WD 22 in response to the control signal. The selection of the second network node 16b being based at least on an inter-network delay between the first and second network nodes 16a, 16b and a PDCCH demand of the WD 22. UL data requirements are determined for communication between the WD 22 and the first network node 16a.

In some embodiments, the method includes transmitting, to the second network node 16b, a request to build and transmit the control signal including a DCI grant to the WD 22, the request including information for building the DCI grant. A confirmation is received from the second network node 16b based on the transmitted request. The method also includes confirming UL resources, waiting for WD data, receiving WD data, and updating load and inter-network delay information. In addition, a retransmission request is transmitted to the second network node 16b when one of the UL data on a physical uplink shared channel (PUSCH) is not decoded and the control signal on PDCCH is not received by the WD 22.

In other embodiments, the method includes determining an alignment time interval based on network variations and an inter-network delay. The method further includes, after the alignment time interval elapses, aligning slots and resources in which the second network node 16b transmits the DCI and the first network node 16a one of (a) receives the UL data on a PUSCH from the WD 22 and (b) transmits downlink data on a physical downlink shared channel (PDSCH) to the WD 22.

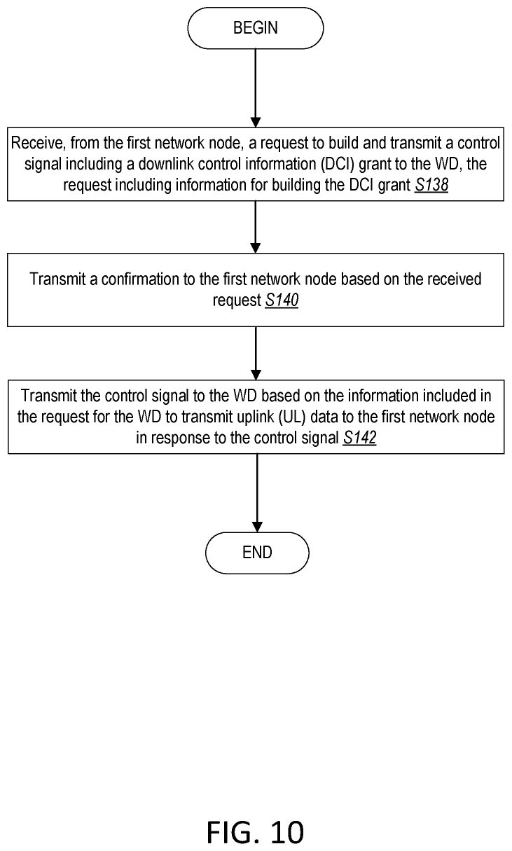

In some other embodiments, the method includes, when one of the second network node 16b and the WD 22 is not available for the cross-carrier scheduling, increasing downlink resources of one of the first network node 16a and the second network node 16b, offloading the second network node 16b from other WDs 22 to decrease a load on the second network node 16b, and modifying a UL scheduling. FIG. 10 is a flowchart of an example method in a second network node 16b, e.g., SCell, for cross-carrier scheduling according to some embodiments of the present disclosure. One or more blocks described herein may be performed by one or more elements of network node 16b which are the same or similar to the elements of network node 16a, such as node scheduling unit 32b. The method includes receiving (Block S138), from the first network node 16a, a request to build and transmit a control signal including a downlink control information (DCI) grant to the WD 22. The request includes information for building the DCI grant. In addition, the method includes transmitting (Block S140) a confirmation to the first network node 16a based on the received request. The control signal is transmitted (Block S142) to the WD 22 based on the information included in the request for the WD 22 to transmit uplink (UL) data to the first network node 16a in response to the control signal. In some embodiments, the method further includes receiving a retransmission request from the first network node 16a when one of a physical uplink shared channel (PUSCH) is not decoded and a physical downlink control channel (PDCCH) is not received by the WD 22, and retransmitting the control signal including the DCI grant to the WD 22 and including one of a new UL scheduling information, an elevated PDCCH aggregation level, and an elevated power level. In one embodiment, the first network node 16a is a Primary Cell (PCell) operating within a first Frequency Range (FR1) and the second network node 16b is Secondary Cell (SCell) operating within a second Frequency Range (FR2).

In some other embodiments, the method further includes, after receiving the request to build and transmit the control signal, determining an amount of PDCCH resources to serve the WD 22 based on current downlink (DL) channel conditions and a traffic load. In other embodiments, the method further includes transmitting, to a third network node 16c, the control signal including the DCI grant indicating a physical uplink shared channel (PUSCH) grant.

In another embodiment, DCI is indicated for DL data scheduling for the WD 22 to receive PDCCH with the DCI from the second network node 16b. In some embodiments, the method further includes, after an alignment time interval elapses, aligning slots and resources in which the second network node 16b transmits DCI and the first network node 16a one of receives PUSCH from the WD 22 and transmits PDSCH to the WD 22.

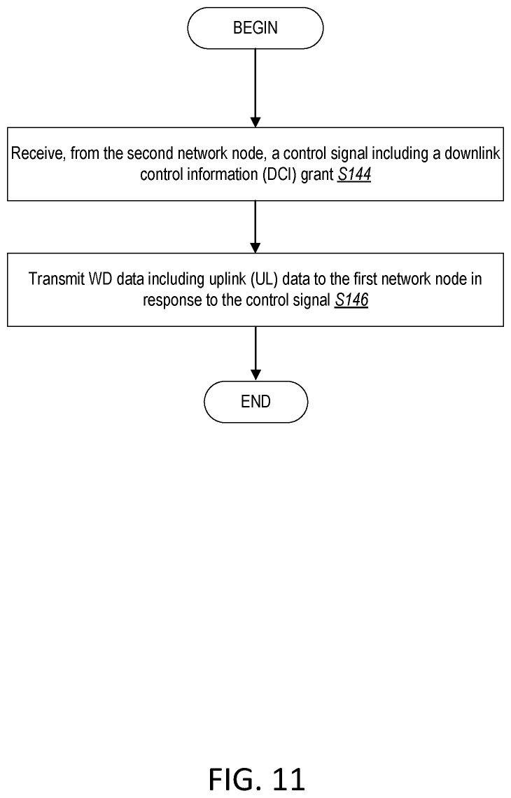

FIG. 11 is a flowchart of an example method in a WD 22 for cross-carrier scheduling according to some embodiments of the present disclosure. One or more blocks described herein may be performed by one or more elements such as by one or more of processing circuitry 84 (including the WD scheduling unit 34), processor 86, radio interface 82 and/or communication interface 60. The method includes receiving (Block S144), such as via processing circuitry 84 and/or processor 86 and/or radio interface 82, from the second network node 16b, a control signal including a downlink control information (DCI) grant. In addition, WD data including uplink (UL) data to the first network node 16a in response to the control signal is transmitted (Block S146), such as via processing circuitry 84 and/or processor 86 and/or radio interface 82.

In some embodiments, the method further includes transmitting a message indicating the WD 22 supports a communication with the first network node 16a and the second network node 16b using the cross-carrier scheduling. The method also includes receiving a configuration to decode the DCI in the control signal. In some other embodiments, the first network node 16a is a Primary Cell (PCell) operating within a first Frequency Range (FR1) and the second network node 16b is Secondary Cell (SCell) operating within a second Frequency Range (FR2).

In an embodiment, a retransmission of the control signal is received including the DCI grant and including one of a new uplink (UL) scheduling information, an elevated physical downlink control channel (PDCCH) aggregation level, and an elevated power level. In another embodiment, the method includes receiving an indication of a DCI for downlink (DL) data scheduling for the WD 22 to receive PDCCH with the DCI from the second network node 16b.

In yet another embodiment, the method further includes, after an alignment time interval elapses, receiving aligned slots and resources in which the second network node 16b transmits the DCI and the first network node 16a one of receives the UL data on a physical uplink shared channel (PUSCH) from the WD 22 and transmits downlink data on a physical downlink shared channel (PDSCH) to the WD 22.

In some embodiments, the method further includes, when one of the second network node 16b and the WD 22 is not available for the cross-carrier scheduling, receiving increased downlink resources of one of the first network node 16a and the second network node 16b, receiving a message to offload from the second network node 16b, and receiving a modified UL scheduling.

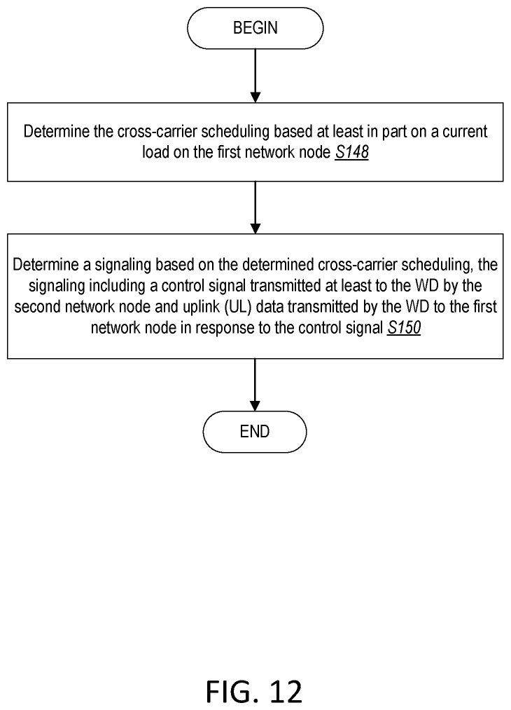

FIG. 12 is a flowchart of another example method in a first network node for cross-carrier scheduling according to some embodiments of the present disclosure. One or more blocks described herein may be performed by one or more elements of network node 16a such as by one or more of processing circuitry 68 (including the node scheduling unit 32a), processor 70, radio interface 62 and/or communication interface 60. The method includes determining (Block S148), such as via processing circuitry 68 and/or processor 70 and/or radio interface 62 and/or communication interface 60, a cross-carrier scheduling based at least in part on a first network load on the first network node 16a. In addition, a signaling is determined (Block S150), such as via processing circuitry 68 and/or processor 70 and/or radio interface 62 and/or communication interface 60, based on the determined cross-carrier scheduling, the signaling including a control signal transmitted at least to the WD 22 by the second network node 16b and uplink (UL) data transmitted by the WD 22 to the first network node 16b in response to the control signal.

In some embodiments, the method further includes determining whether the WD 22 supports the cross-carrier scheduling based on a field of a WD capability message; and configuring the WD 22 to decode downlink control information, DCI, in the control signal transmitted by the second network node 16b and at least one of decode downlink, (DL), data from the first network node 16a and transmit UL data.

In some other embodiments, the method further includes determining a physical downlink control channel (PDCCH) of the first network node 16a is congested; selecting the second network node 16b for transmission of the control signal to the WD 22, where the selection of the second network node 16b is based at least on an inter-network delay between the first and second network nodes 16a, 16b and a PDCCH demand of the WD 22; and determining UL data requirements for communication between the WD 22 and the first network node 16a.

In one embodiment, the method further includes at least one of determining an alignment time interval based on network variations and an inter-network delay; and after the alignment time interval elapses, aligning slots and resources in which the second network node 16b transmits the DCI and the first network node 16a one of receives UL data on a PUSCH from the WD 22 and transmits downlink data on a physical downlink shared channel (PDSCH) to the WD 22.

In another embodiment, the method further includes, when at least one of the second network node 16b and the WD 22 is not available for the cross-carrier scheduling, at least one of: increasing downlink resources of one of the first network node 16a and the second network node 16b; offloading the second network node 16b from other WDs 22 to decrease a second network load on the second network node 16b; and modifying a UL scheduling process.

In some embodiments, the method further includes: transmitting, to the second network node 16b, a request to build and transmit the control signal including a DCI grant to the WD 22, where the request includes information for building the DCI grant; receiving, from the second network node 16b, a confirmation based on the request; receiving WD data and update network load information and inter-network delay information based on the received WD data; and transmitting, to the second network node 16b, a retransmission request when one of UL data on a physical uplink shared channel (PUSCH) is not decoded and the control signal on PDCCH is not received by the WD 22.

In some other embodiments, the first network node 16a is a Primary Cell, PCell, operating within a first Frequency Range (FR1) and the second network node 16b is Secondary Cell (SCell) operating within a second Frequency Range (FR2).

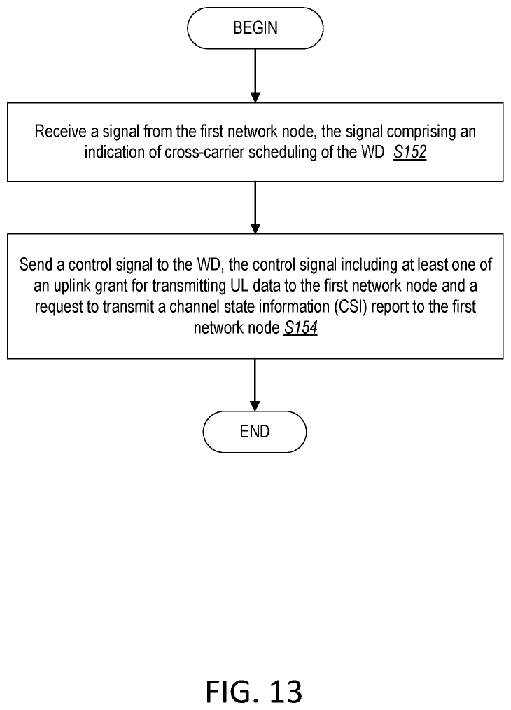

FIG. 13 is a flowchart of another example method in a second network node for cross-carrier scheduling according to some embodiments of the present disclosure. One or more blocks described herein may be performed by one or more elements of network node 16b which are the same or similar to the elements of network node 16a, such as node scheduling unit 32b. The method includes receiving (Block S152), such as via radio interface 62 and/or processing circuitry 68 and/or node scheduling unit 32b, a signal from the first network node 16a, the signal comprising an indication of cross-carrier scheduling of the WD 22. The method further includes sending (e.g., transmitting) (Block S154), such as via radio interface 62 and/or processing circuitry 68 and/or node scheduling unit 32b, a control signal to the WD 22, the control signal including at least one of an uplink grant for transmitting UL data to the first network node 16a and a request to transmit a channel state information (CSI) report to the first network node 16a.

In some embodiments, the method further includes at least one of: determining an alignment time interval based on network variations and an inter-network delay; and after the alignment time interval elapses, aligning slots and resources in which the second network node 16b transmits downlink control information (DCI); and the first network node 16a one of receives the UL data on a PUSCH from the WD 22 and transmits downlink data on a physical downlink shared channel (PDSCH) to the WD 22.

In some other embodiments, the method further includes receiving, from the first network node 16a, a request to build and transmit the control signal including a DCI grant to the WD 22, the request including information for building the DCI grant; transmitting, to the first network node 16a, a confirmation based on the received request; and transmitting, to the WD 22, the control signal.

In one embodiment, the method further includes receiving, from the first network node 16a, a retransmission request associated with at least one of UL data on a physical uplink shared channel (PUSCH) not being decoded by the first network node 16a and the control signal not being received by the WD 22; and retransmitting the control signal to the WD 22 and including one of a UL scheduling information, an elevated PDCCH aggregation level, and an elevated power level.

In another embodiment, the method further includes transmitting, to a third network node, the control signal including the DCI grant indicating a physical uplink shared channel, PUSCH, grant.

In some embodiments, the method further includes, after receiving the request to build and transmit the control signal, determining an amount of PDCCH resources to serve the WD 22 based at least one of a current downlink, DL, channel conditions and a traffic load.

In one embodiment, the method further includes determining a DCI associated with DL data scheduling, the DCI to be transmitted by the second network node 16b to the WD 22.

In another embodiment, the first network node 16a is a Primary Cell, PCell, operating within a first Frequency Range (FR1) and the second network node 16b is Secondary Cell (SCell) operating within a second Frequency Range (FR2).

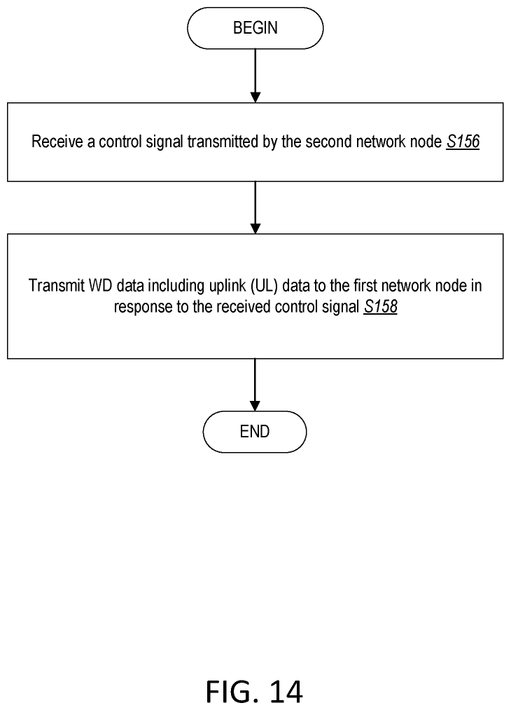

FIG. 14 is a flowchart of another example method in a wireless device for cross-carrier scheduling according to some embodiments of the present disclosure. One or more blocks described herein may be performed by one or more elements such as by one or more of processing circuitry 84 (including the WD scheduling unit 34), processor 86, radio interface 82 and/or communication interface 60. The method includes receiving (Block S156), such as via processing circuitry 84 and/or processor 86 and/or radio interface 82, a control signal transmitted by the second network node 16b and transmitting (Block S158), such as via processing circuitry 84 and/or processor 86 and/or radio interface 82, WD data including uplink (UL) data to the first network node 16a in response to the received control signal.

In some embodiments, the control signal includes a downlink control information (DCI) grant for the UL data to be transmitted to the first network node 16a.

In some other embodiments, the method further includes transmitting a message indicating the WD 22 supports communication with the first network node 16a and the second network node 16b using cross-carrier scheduling.

In one embodiment, the method further includes, after an alignment time interval elapses, receiving aligned slots and resources in which the second network node 16b transmits the DCI and the first network node 16a one of receives the UL data on a physical uplink shared channel (PUSCH) from the WD 22 and transmits downlink data on a physical downlink shared channel (PDSCH) to the WD 22.

In another embodiment, the method further includes receiving a retransmission of the control signal from the second network node 16b, the retransmission including the DCI grant and including one of a new uplink, UL, scheduling information, an elevated physical downlink control channel (PDCCH) aggregation level, and an elevated power level.

In some embodiments, the method further includes, when one of the second network node 16b and the WD 22 is not available for cross-carrier scheduling, at least one of: receiving increased downlink resources of one of the first network node 16a and the second network node 16b; receiving an offload message to offload from the second network node 16b; and receiving a modified UL scheduling.

Having described the general process flow of arrangements of the disclosure and having provided examples of hardware and software arrangements for implementing the processes and functions of the disclosure, the sections below provide details and examples of arrangements for cross-carrier scheduling in carrier aggregation.

Some embodiments provide enhanced cross-carrier scheduling in FR1-FR2 carrier aggregation. The following steps summarize an example method according to the principles of the present disclosure. At step 1, cross-carrier scheduling capable WDs 22 are identified, based on a WD capability message sent from the WD 22 to the serving network nodes 16, e.g., gNBs. At step 2, a need for cross-carrier scheduling is identified, which is estimated based on a current load on the first network node 16a, e.g., PCell, due to existing CA WDs and non-CA WDs, and a number of other network nodes 16, e.g., serving as SCells. At step 3, an optimal and feasible type for cross-carrier scheduling is selected, e.g., by taking into account delay requirements for different data types, e.g., delay sensitive applications, or CSI report for FR2 beam management. In a non-limiting example, an “optimal” type for cross-carrier scheduling leads to an adjustment of Key Performance Indicators (KPIs) associated with a WD 22 and/or a cell level. An inter-network node, e.g., inter-gNB link, delay may be used to identify a design for cross carrier scheduling and provide alternatives for reliable data scheduling.

At step 4, new signaling processes and WD behavior for cross-carrier scheduling are defined. At step 5, based on feedback from other network nodes 16, e.g., SCells, and WD 22, different scheduling algorithms can be selected to avoid bottlenecks identified during runtime and further enhance the performance of the cross-carrier scheduling.

Embodiments 1 and 2 below provide non-limiting recommendations at least for 3GPP implementation for steps 1 and 4. All the remaining embodiments provide examples of non-limiting implementations for the other steps which may be internal and proprietary for network node, e.g., gNB, vendors.

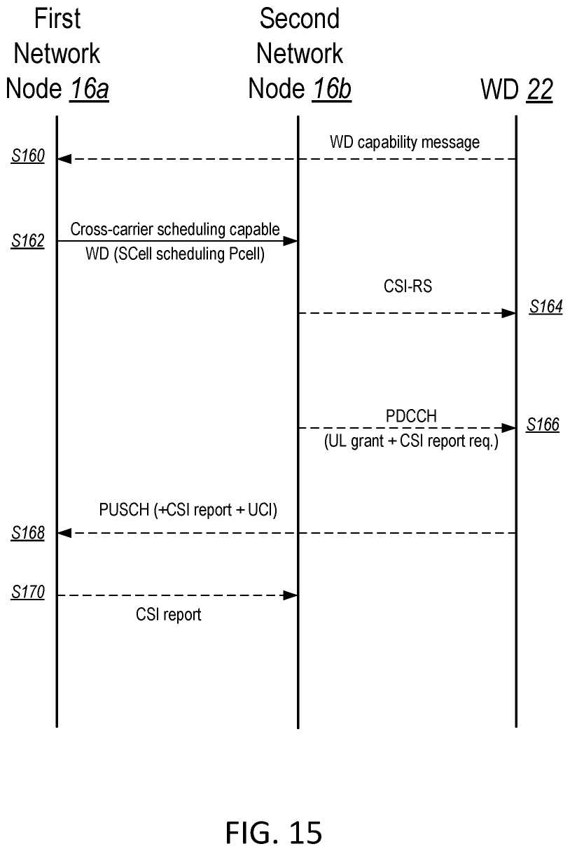

FIG. 15 is a signal diagram of an example process for cross-carrier scheduling where a second network node, e.g., SCell FR2, transmits DCI and a WD 22 transmits data to a first network node 16a, e.g., PCell FR1, according to some embodiments of the present disclosure. At step S160, WD 22 transmits a WD capability message to the first network node 16a, e.g., PCell. The first network node 16a transmits, at step S162, a signal to the second network node 16b, e.g., SCell, including an indication of cross-carrier scheduling capable WDs 22. The signal may include whether the first network node 16a and/or the second network node 16b is performing scheduling. At step 164, the second network node 16b may transmit a Channel State Information Reference Signal, CSI-RS, to the WD 22. In addition, the second network node 16b may transmit a control signal, e.g., on a PDCCH, including a UL grant and/or a CSI report request at step S166. At step S168, the WD 22 transmits to the first network node 16a a signal including a PUSCH and/or a CSI report and/or Uplink Control Information, UCI. The first network node 16a then may transmit a CSI report to the second network node 16b at step S170.

### Embodiment 1: Configuring WDs

An indication of FR1 UL resources can be done by sending a DCI based indication where the PDCCH is sent from the second network node 16b, e.g., SCell, to the WD 22 indicating the grant on the FR1 carrier. The WD 22 may decode the DCI in a PDCCH and transmit UL data (e.g., via PUSCH) to the first network node 16a, e.g., FR1 PCell, or any other network node 16, e.g., a SCell in FR1. The WD 22 may be configured with the following:
PCell: FR1, SCell 1: FR2
PCell: FR1, SCell 1: FR1, SCell 2: FR2

A carrier index of the PCell of the other SCell is indicated in the DCI. Due to the difference in numerology between SCell sending the DCI and the PCell or SCell FR1 expecting to receive the UL shared channel, the WD 22 shall report the data according to the configured offset computed using the smaller numerology slot duration. For instance, if the SCell FR2 indicates a slot offset K2, and the PCell, expecting the UL data from WD 22, is using numerology 0 (i.e., slot duration=1 ms), the WD will send the UL data K2*1 ms after receiving the DCI from the SCell. The WD 22 may also multiplex other UL information on the transmitted PUSCH such as CSI report or UCI (e.g., indicating HARQ feedback for DL transmissions from PCell or SCell).

### Embodiment 2: Identifying Capable WDs

The first network node 16a, e.g., PCell, is able to identify WDs 22 who are capable of decoding DCI from the second network node 16b, e.g., SCell, scheduling data on PCell as described in Embodiment 1. This can be done by updating the WD capability message to add a field indicating that the WD 22 supports cross-carrier scheduling with SCell scheduling UL/DL data on PCell or other SCells. If the capability field is missing, the WD 22 doesn't support cross-carrier scheduling.

### Embodiment 3: PCell-SCell Coordination and Inter-gNB Based Cross-Carrier UL Scheduling

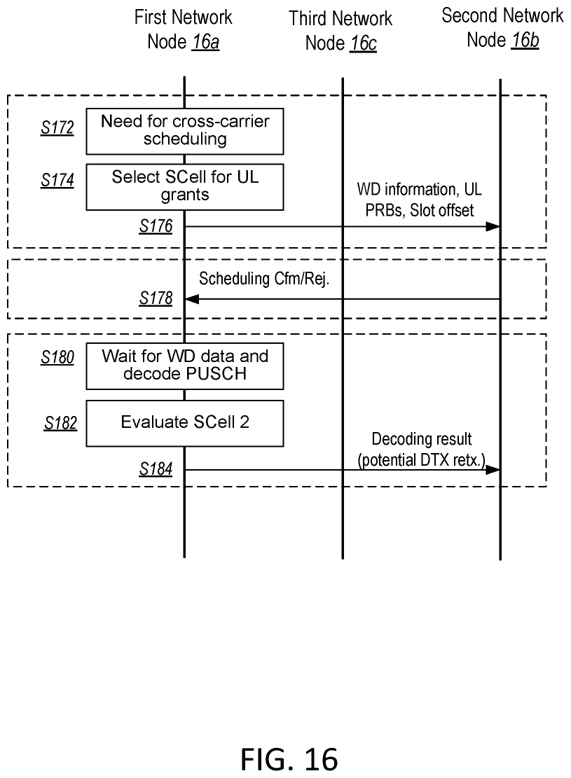

After the first network node 16a, e.g., PCell, identifies that the WD 22 is capable of communicating using cross-carrier scheduling with control channels from the second network node 16b, e.g., SCell (e.g., per Embodiment 2), then the PCell initiates the following process which involves coordination with SCells as depicted in FIG. 16. FIG. 16 is a signal diagram of an example process where a first network node 16a, e.g., a PCell, selects and coordinates with a second network node 16b, e.g., a SCell, for cross carrier scheduling with DCI grant from the second network node 16b according to some embodiments of the present disclosure.

At step S172, the first network node 16a, e.g., PCell, identifies a need for cross-carrier scheduling, and, at step S174, selects a second network node 16b, SCell, for UL grants. At step S176, the first network node 16a transmits WD information and/or UL physical resource blocks, PRBs, and/or a slot offset to the second network node 16b. At step S178, the second network node 16b transmits to the first network node 16a a scheduling confirmation or rejection. At step S180, the first network node 16a waits for WD data and decoded PUSCH. The first network node 16a then evaluates, at step S182, the second network node 16b, e.g., SCell, and transmits a decoding result, including potential DTX retransmissions, to the second network node 16b, at step S184.

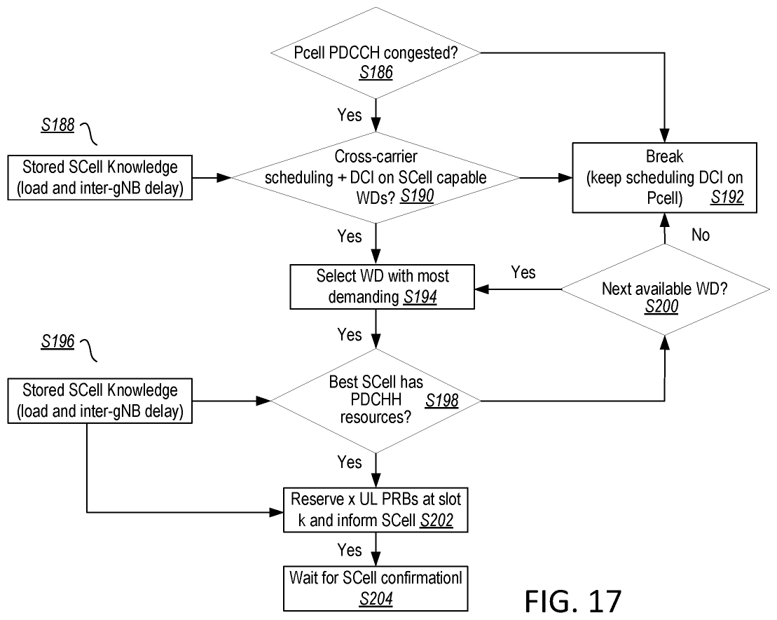

FIG. 17 is a flowchart of an example process in a first network node 16a for cross-carrier UL scheduling based on coordination between a first network node 16a and second network node 16b, e.g., PCell-SCell, inter-gNB, according to some embodiments of the present disclosure. At step S186, the process includes determining whether a control channel, e.g., PDCCH, of the first network node 16a, e.g., PCell, is congested. If congested, the process includes determining, at step S190, whether WDs 22 are capable of cross-carrier scheduling and DCI on the second network node 16b, e.g., SCell, based on SCell knowledge, including load and inter-gNB delay, stored at step S188. If there is at least a capable WD 22, then WD 22 is selected at S194. If there are no capable WDs 22, scheduling continues, at step S192, on the first network node 16a. Step S194 may include selecting the most demanding WD 22, such as from a PDCCH load perspective (e.g., high aggregation levels). Based on the stored SCell knowledge at step S196, the process determines, at step S198, whether the SCell has PDCCH resources, such as PDCCH resources that are vacant/extra. If the SCell has no PDCCH resources, then the process continues to determine, at step S200, whether there are additional available WDs 22, such as WDs 22 having a PDCCH demand that may be offloaded to the SCell. If there are additional available WDs 22, the process proceeds to step S194. If there are no additional available WDs 22 then the process proceeds to step S192.

If at step S198, PDCCH resources on the SCell are found, then UL PRBs at slot k are reserved and the second network node 16b, SCell, is informed. Then, at step S204 the first network node 16a waits for the SCell to confirm.

More specifically, PCell checks whether its current PDCCH is congested when one of the following conditions is satisfied:
Total PDCCH need for CA and non-CA WDs>threshold (function of the BW)
Total PDCCH need for CA WDs>threshold (function of BW and WD priority)
Delay of data transmission (due to PDCCH resource unavailability)>threshold
Scheduling CSI reports delayed due to lack of PDCCH

If the PCell has some WDs 22 capable of cross carrier scheduling with DCI on SCell (i.e., satisfies Embodiment 1 and 2), then the PCell will select the WD 22 with the most demanding PDCCH as long as the WD 22 has an SCell with vacant PDCCH resources, where SCells with smallest inter-gNB delay are checked first due to the ease of coordination with PCell. An example process is as follows:

```
▪ Define Set L of complaint WDs, sorted by their PDCCH demand
▪ Initialize i =0;
▪ While i< |L|
      • Define Set S as the activated SCells for UE i, sorted according
          to the inter-gNB link delay
        • Initialize: s = 0;
        • While s < |S|
            ∘ (PDCCH capacity of SCell s − PDCCH load of SCell
              s) < PDCCH demand of UE i
            ∘ Define thresholdK as the maximum delay for
                transmitting PUSCH by the WD after receiving DCI
                from FR2 SCell
            ∘ IF inter-gNB delay between PCell and SCell s <
                thresholdK
                ▪ Select SCell s and WD i; and terminate the WD
                    and SCell selection algorithm
            ∘ ELSE
                  ▪ s =s+1
            ∘ ENDIF
        • EndWhile
▪ EndWhile
▪ i = i+1
▪ EndWhile
```

If the above example process has successfully selected a SCell and WD 22, then the method, i.e., algorithm, proceeds as follows. Otherwise, Embodiment 7 may be integrated to provide other UL scheduling processes.

The PCell calculates the amount of needed PUSCH PRBs for that WD 22, and calculates the scheduling offset, i.e., K2. Where the latter is based on the inter network node, e.g., inter-gNB, delay in order to guarantee that the PUSCH arrives from the WD 22 at the PCell not before the PCell-SCell coordination is completed.
PCell-SCell Information exchange
PCell side: as illustrated in FIG. 17, the PCell will send the information needed by SCell for building DCI grant to the WD 22, including for instance the scheduling offset (K2) and the number of PRBs allocated, HARQ process ID, an indicator for CSI report, etc. The PCell will wait for a confirmation message from the SCell to finalize the PRBs reservation of UL resources and inform the receiver to wait for and decode upcoming WD data.

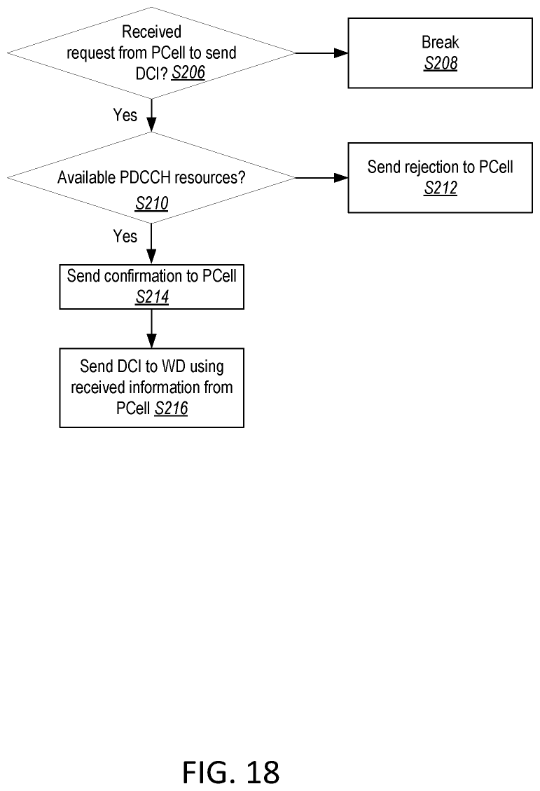

SCell side: as illustrated in FIG. 18, at step S206, the SCell determines whether a request from the PCell has been received to transmit DCI. If no request has been received, the process is stopped at step S208, i.e., a break is introduced. After receiving the request from PCell, SCell will check, at step S210, the amount of needed PDCCH resources to serve the WD 22 which is based on his current DL channel conditions and traffic load. If the SCell can serve the demand without impacting other users, which may be determined based on priorities, then a confirmation message is sent to the PCell at step S214, and DCI is sent to the WD at step S216 using received information from the PCell. Otherwise, the SCell will send a rejection to the PCell at step S212.

Post Coordination and Scheduling

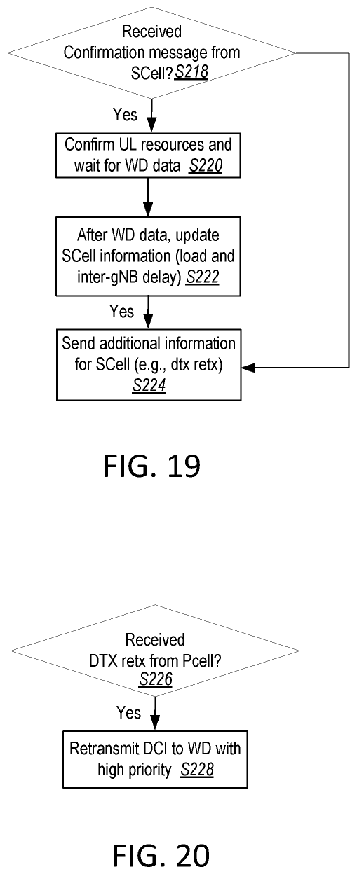

PCell side: as illustrated in FIG. 19, if the confirmation message does not arrive from the SCell or the SCell sends a rejection message, the PCell will update the SCell information with the new inter-gNB delay and the load of SCell, assuming high load is a reason for rejection. This will allow a selection for SCell to send DCI for cross-carrier scheduling. The PCell will later receive the PUSCH from the WD 22, and in the case of HARQ retransmission (e.g., PUSCH not decoded) or Discontinuous Transmission (DTX) retransmission (e.g., PDCCH is not received by the WD 22), then a request is sent towards the SCell.

More specifically, at Step S218 the PCell determines whether a confirmation message from the SCell has been received. If the confirmation message is received, the PCell confirms UL resources and waits for WD data at step S220. At step S222, after WD data is received, the PCell updates the SCell information (e.g., load and inter-gNB delay) and, at step S224, sends additional information for SCell. If no confirmation message is received at step S218, the process goes directly to step S224.

SCell side: as illustrated in FIG. 20, in case of a retransmission (Retx) request is received, at step S226, from the PCell, the SCell will retransmit, at step S228, the DCI either with new UL scheduling information if the Retx request is a HARQ retx, or with old UL scheduling information but with higher PDCCH aggregation level or higher power to ensure proper reception of PDCCH and avoid DTX retransmissions. The request will be fulfilled by SCell as a high priority. Sending back confirmation to PCell is not needed.

### Embodiment 4: SCell FR2 Scheduling on Another SCell

An alternative to Embodiment 3 is to perform cross-carrier scheduling where SCell FR2 sends DCI indicating PUSCH grant for another SCell, either FR1 or FR2, with better UL coverage, which may be if both PDCCH and PUSCH on PCell are congested. Coordination between SCells can either occur in a distributed way, e.g., both SCells are communicating directly, or in a centralized way, e.g., PCell is an information hub.

### Embodiment 5: DL Cross-Carrier Scheduling

Embodiment 5 is similar to Embodiments 3 and 4, but the SCell is indicating DCI for DL data scheduling. The WD 22 receives PDCCH with DCI from SCell, while the PDSCH will be sent from an FR1 PCell or an FR1 SCell.

It is noted that all embodiments are applicable to Non-Stand Alone (NSA) and/or Stand Alone (SA), where the PCell can be also a Primary SCell (PSCell) in the case of NSA.

### Embodiment 6: Reserved UL Allocation for Long Inter-gNB Delay

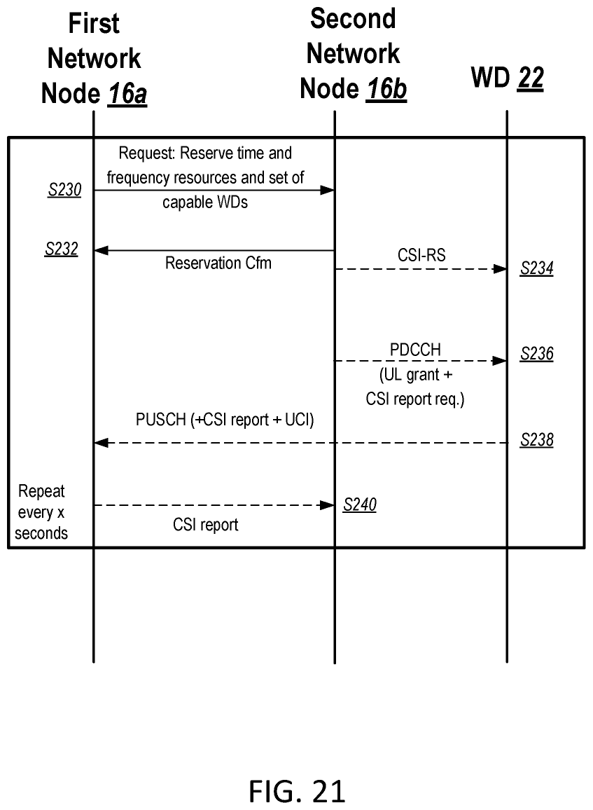

In Embodiments 3-5, Embodiment 6 provides an alternative to the coordination between PCell and SCell in a case of long inter-network node, e.g., inter-gNB, link delay, especially when some UL traffic may have stringent delay requirements, such as aperiodic CSI report or delay sensitive user data (e.g., live video streaming). PCell and SCell may align on the slots and resources in which the SCell will send DCI and in which the PCell expects PUSCH from the WD 22 or sends PDSCH to the WD 22, as illustrated in FIG. 21.

FIG. 21 is a flowchart of an example process for reserved UL allocation based on a delay between network nodes 16, e.g., an inter-gNB delay, according to some embodiments of the present disclosure. At step S230, the first network node 16a, e.g., PCell, transmits a request to the second network node 16b, e.g., SCell, such as to reserve time and frequency resources and a set of capable WDs 22. At step S232, the second network node 16b transmits a confirmation to the first network node 16a, and, at step S234, transmits a CSI-RS to the WD 22. At S236, the second network node 16b also transmits to the WD 22 a control signal, e.g., on PDCCH, including a UL grant and/or a CSI report request. At step S238, the WD 22 transmits a signal, e.g., on PUSCH, including a CSI report and/or UCI. At step S240, the first network node 16a transmits a CSI report to the second network node 16b. Steps S230-S240 are repeated every x seconds. The value of x may be a predetermined amount.

More specifically, the alignment on time and frequency resources in which the second network node 16b, e.g., SCell, will send DCI while the first network node 16a, e.g., PCell, will receive PUSCH or send PDSCH occurs every x ms, where x is calculated based on network variations and inter-gNB delay. Large inter-gNB delay and static network conditions may result in a large value of x and vice versa (e.g., small inter-gNB delay or dynamic network conditions results in a small value of x). After every x ms, the requested resources are recomputed.

An example of requested resources from PCell to SCell for a “WD i” may be the number of PRBs (Ri) at each time slot (Ti):
Ri={10, 5, 0, 0, 0, 15}
Ti={0, 1, 2, 3, 4, 5}

The SCell will send a confirmation message in the case of available PDCCH resources which is also based on the priority of the carrier aggregation WDs and the other WDs served by the SCell.

### Embodiment 7: Selecting UL Scheduling Algorithm

As described in Embodiment 3, there may be a possibility that no SCells and/or WDs 22 are available for cross-carrier scheduling. In such case, an example process may be performed to address PDCCH congestion at the PCell, e.g., for carrier aggregated users, by either reconfiguring resources of the PCell and the SCell, or changing the UL scheduling process. The example process is as follows:

Define:
P_PDCCH_flag=true if the PCell PDCCH is congested
S_PDCCH_flag=true if the best SCell PDCCH is congested
UE_cross_flag=true if there are WDs supporting cross-carrier scheduling with DCI on SCell and PUSCH/PDSCH on PCell
P_PDCCH_config is the current configured number of PDCCH resources for PCell to use
P_PDCCH_max is the maximum number of PDCCH resources that can be configured on PCell
S_PDCCH_config is the current configured number of PDCCH resources for SCell to use
S_PDCCH_max is the maximum number of PDCCH resources that can be configured on SCell
Si: set of activated SCells for WD i

```
- Start
    ∘ IF P_PDCCH_flag AND P_PDCCH_config < P_PDCCH_max AND
        NOT(UE_cross_flag)
        ▪ Then, Increase the number of configured PDCCH resources on
            PCell (e.g., increase the number of PDCH symbols by 1)
        ▪ Use PCell for sending PDCCH
    ∘ ELSEIF S_PDCCH_config AND S_PDCCH_config <
        S_PDCCH_max AND UE_cross_flag
        ▪ Then, Increase the number of configured PDCCH resources on
            SCell (e.g., increase the number of PDCH symbols by 1)
        ▪ This will increase the chance of offloading the PDCCH
            allocation to SCells
    ∘ ELSE //consider offloading SCells from other WDs
        ▪ ForEach CA WD i
            • Request each Si to offload some of the local users to
                other neighbor cells in order to decrease the load on
                PDCCH load on SCell
        ▪ EndForEach
    ∘ END
- End
```

The following is a nonlimiting list of embodiments according to the present disclosure:

Embodiment A1. A first network node configured to communicate at least with a second network node and a wireless device (WD) using a cross-carrier scheduling, the first network node configured to, and/or comprising a radio interface and/or comprising processing circuitry configured to:
determine the cross-carrier scheduling based at least on a current load on the first network node; and
determine a signaling based on the determined cross-carrier scheduling, the signaling including at least a control signal transmitted by the second network node at least to the WD and uplink (UL) data received by the first network node from the WD in response to the control signal.

Embodiment A2. The first network node of Embodiment A1, wherein the first network node and/or the radio interface and/or the processing circuitry is further configured to:
determine whether the WD supports the cross-carrier scheduling based on a field of a WD capability message; and
configure the WD to decode a downlink control information (DCI) in the control signal transmitted by the second network node and to one of transmit the UL data and decode downlink (DL) data from the first network node.

Embodiment A3. The first network node of Embodiment A1, wherein the first network node is a Primary Cell (PCell) operating within a first Frequency Range (FR1) and the second network node is Secondary Cell (SCell) operating within a second Frequency Range (FR2).

Embodiment A4. The first network node of Embodiment A1, wherein the first network node and/or the radio interface and/or the processing circuitry is further configured to:
determine a physical downlink control channel (PDCCH), of the first network node is congested;
select the second network node for transmission of the signaling including at least the control signal transmitted by the second network node at least to the WD and the UL data received by the first network node from the WD in response to the control signal, the selection of the second network node being based at least on an inter-network delay between the first and second network nodes and a PDCCH demand of the WD; and
determine UL data requirements for communication between the WD and the first network node.

Embodiment A5. The first network node of Embodiment A1, wherein the first network node and/or the radio interface and/or the processing circuitry is further configured to:
transmit, to the second network node, a request to build and transmit the control signal including a DCI grant to the WD, the request including information for building the DCI grant;
receive a confirmation from the second network node based on the transmitted request;
confirm UL resources and wait for WD data;
receive WD data and update load and inter-network delay information; and
transmit a retransmission request to the second network node when one of the UL data on a physical uplink shared channel (PUSCH) is not decoded and the control signal on PDCCH is not received by the WD.

Embodiment A6. The first network node of Embodiment A1, wherein the first network node and/or the radio interface and/or the processing circuitry is further configured to:
determine an alignment time interval based on network variations and an inter-network delay; and
after the alignment time interval elapses, align slots and resources in which the second network node transmits the DCI and the first network node one of receives the UL data on a PUSCH from the WD and transmits downlink data on a physical downlink shared channel (PDSCH) to the WD.

Embodiment A7. The first network node of Embodiment A1, wherein the first network node and/or the radio interface and/or the processing circuitry is further configured to perform one of:
when one of the second network node and the WD is not available for the cross-carrier scheduling:
   increase downlink resources of one of the first network node and the second network node;
   offload the second network node from other WDs to decrease a load on the second network node; and
   modify a UL scheduling.

Embodiment B1. A method implemented in a first network node configured to communicate at least with a second network node and a wireless device (WD) using a cross-carrier scheduling, the method comprising:
determining the cross-carrier scheduling based at least on a current load on the first network node; and
determining a signaling based on the determined cross-carrier scheduling, the signaling including at least a control signal transmitted by the second network node at least to the WD and uplink (UL) data received by the first network node from the WD in response to the control signal.

Embodiment B2. The method of Embodiment B1, further including:
determining whether the WD supports the cross-carrier scheduling based on a field of a WD capability message; and
configuring the WD to decode a downlink control information (DCI) in the control signal transmitted by the second network node and to one of transmit the UL data and decode downlink (DL) data from the first network node.

Embodiment B3. The method of Embodiment B1, wherein the first network node is a Primary Cell (PCell) operating within a first Frequency Range (FR1) and the second network node is Secondary Cell (SCell) operating within a second Frequency Range (FR2).

Embodiment B4. The method of Embodiment B1, further including:
determining a physical downlink control channel (PDCCH), of the first network node is congested;
selecting the second network node for transmission of the signaling including at least the control signal transmitted by the second network node at least to the WD and the UL data received by the first network node from the WD in response to the control signal, the selection of the second network node being based at least on an inter-network delay between the first and second network nodes and a PDCCH demand of the WD; and
determining UL data requirements for communication between the WD and the first network node.

Embodiment B5. The method of Embodiment B1, further including:
transmitting, to the second network node, a request to build and transmit the control signal including a DCI grant to the WD, the request including information for building the DCI grant;
receiving a confirmation from the second network node based on the transmitted request;
confirming UL resources and wait for WD data;
receiving WD data and update load and inter-network delay information; and
transmitting a retransmission request to the second network node when one of the UL data on a physical uplink shared channel (PUSCH) is not decoded and the control signal on PDCCH is not received by the WD.

Embodiment B6. The method of Embodiment B1, further including:
determining an alignment time interval based on network variations and an inter-network delay; and
after the alignment time interval elapses, aligning slots and resources in which the second network node transmits the DCI and the first network node one of receives the UL data on a PUSCH from the WD and transmits downlink data on a physical downlink shared channel (PDSCH) to the WD.

Embodiment B7. The method of Embodiment B1, further including:
when one of the second network node and the WD is not available for the cross-carrier scheduling:
   increasing downlink resources of one of the first network node and the second network node;
   offloading the second network node from other WDs to decrease a load on the second network node; and
   modifying a UL scheduling.

Embodiment C1. A second network node configured to communicate at least with a first network node and a wireless device (WD) using a cross-carrier scheduling, the second network node configured to, and/or comprising a radio interface and/or comprising processing circuitry configured to:
receive, from the first network node, a request to build and transmit a control signal including a downlink control information (DCI) grant to the WD, the request including information for building the DCI grant;
transmit a confirmation to the first network node based on the received request; and
transmit the control signal to the WD based on the information included in the request for the WD to transmit uplink (UL) data to the first network node in response to the control signal.

Embodiment C2. The second network node of Embodiment C1, wherein the second network node and/or the radio interface and/or the processing circuitry is further configured to:
receive a retransmission request from the first network node when one of a physical uplink shared channel (PUSCH) is not decoded and a physical downlink control channel (PDCCH) is not received by the WD; and
retransmit the control signal including the DCI grant to the WD and including one of a new UL scheduling information, an elevated PDCCH aggregation level, and an elevated power level.

Embodiment C3. The second network node of Embodiment C1, wherein the first network node is a Primary Cell (PCell) operating within a first Frequency Range (FR1) and the second network node is Secondary Cell (SCell) operating within a second Frequency Range, (FR2).

Embodiment C4. The second network node of Embodiment C1, wherein the second network node and/or the radio interface and/or the processing circuitry is further configured to:
after receiving the request to build and transmit the control signal, determine an amount of PDCCH resources to serve the WD based on current downlink (DL) channel conditions and a traffic load.

Embodiment C5. The second network of Embodiment C1, wherein the second network node and/or the radio interface and/or the processing circuitry is further configured to:
transmit, to a third network node, the control signal including the DCI grant indicating a physical uplink shared channel (PUSCH) grant.

Embodiment C6. The second network of Embodiment C1, wherein the second network node and/or the radio interface and/or the processing circuitry is further configured to:
indicate DCI for DL data scheduling for the WD to receive PDCCH with the DCI from the second network node.

Embodiment C7. The second network node of Embodiment C1, wherein the second network node and/or the radio interface and/or the processing circuitry is further configured to:
after an alignment time interval elapses, align slots and resources in which the second network node transmits DCI and the first network node one of receives PUSCH from the WD and transmits PDSCH to the WD.

Embodiment D1. A method implemented in a second network node configured to communicate at least with a first network node and a wireless device (WD) using a cross-carrier scheduling, the method comprising:
receiving, from the first network node, a request to build and transmit a control signal including a downlink control information (DCI) grant to the WD, the request including information for building the DCI grant;
transmitting a confirmation to the first network node based on the received request; and
transmitting the control signal to the WD based on the information included in the request for the WD to transmit uplink (UL) data to the first network node in response to the control signal.

Embodiment D2. The method of Embodiment D1, further including: receiving a retransmission request from the first network node when one of a physical uplink shared channel (PUSCH) is not decoded and a physical downlink control channel (PDCCH) is not received by the WD; and
retransmitting the control signal including the DCI grant to the WD and including one of a new UL scheduling information, an elevated PDCCH aggregation level, and an elevated power level.

Embodiment D3. The method of Embodiment D1, wherein the first network node is a Primary Cell (PCell) operating within a first Frequency Range (FR1) and the second network node is Secondary Cell (SCell) operating within a second Frequency Range (FR2).

Embodiment D4. The method of Embodiment D1, further including:
after receiving the request to build and transmit the control signal, determining an amount of PDCCH resources to serve the WD based on current downlink (DL) channel conditions and a traffic load.

Embodiment D5. The method of Embodiment D1, further including:
transmitting, to a third network node, the control signal including the DCI grant indicating a physical uplink shared channel (PUSCH) grant.

Embodiment D6. The method of Embodiment D1, further including:
indicating DCI for DL data scheduling for the WD to receive PDCCH with the DCI from the second network node.

Embodiment D7. The method of Embodiment D1, further including:
after an alignment time interval elapses, aligning slots and resources in which the second network node transmits DCI and the first network node one of receives PUSCH from the WD and transmits PDSCH to the WD.

Embodiment E1. A wireless device (WD) configured to communicate at least with a first network node and a second network node using a cross-carrier scheduling, the WD configured to, and/or comprising a radio interface and/or processing circuitry configured to:
receive, from the second network node, a control signal including a downlink control information (DCI) grant; and
transmit WD data including uplink (UL) data to the first network node in response to the control signal.

Embodiment E2. The WD of Embodiment E1, wherein the WD and/or the radio interface and/or the processing circuitry is further configured to:
transmit a message indicating the WD supports a communication with the first network node and the second network node using the cross-carrier scheduling; and
receive a configuration to decode the DCI in the control signal.

Embodiment E3. The WD of Embodiment E1, wherein the first network node is a Primary Cell (PCell) operating within a first Frequency Range (FR1) and the second network node is Secondary Cell (SCell) operating within a second Frequency Range (FR2).

Embodiment E4. The WD of Embodiment E1, wherein the WD and/or the radio interface and/or the processing circuitry is further configured to:
receive a retransmission of the control signal including the DCI grant and including one of a new uplink (UL) scheduling information, an elevated physical downlink control channel (PDCCH) aggregation level, and an elevated power level.

Embodiment E5. The WD of Embodiment E1, wherein the WD and/or the radio interface and/or the processing circuitry is further configured to:
receive an indication of a DCI for downlink (DL) data scheduling for the WD to receive PDCCH with the DCI from the second network node.

Embodiment E6. The WD of Embodiment E1, wherein the WD and/or the radio interface and/or the processing circuitry is further configured to:
after an alignment time interval elapses, receive aligned slots and resources in which the second network node transmits the DCI and the first network node one of receives the UL data on a physical uplink shared channel (PUSCH) from the WD and transmits downlink data on a physical downlink shared channel (PDSCH) to the WD.

Embodiment E7. The WD of Embodiment E1, wherein the WD and/or the radio interface and/or the processing circuitry is further configured to:
when one of the second network node and the WD is not available for the cross-carrier scheduling:
   receive increased downlink resources of one of the first network node and the second network node;
   receive a message to offload from the second network node; and
   receive a modified UL scheduling.

Embodiment F1. A method implemented in a wireless device (WD) configured to communicate at least with a first network node and a second network node using a cross-carrier scheduling, the method comprising:
receiving, from the second network node, a control signal including a downlink control information (DCI) grant; and
transmitting WD data including uplink (UL) data to the first network node in response to the control signal.

Embodiment F2. The method of Embodiment F1, further including:
transmitting a message indicating the WD supports a communication with the first network node and the second network node using the cross-carrier scheduling; and
receiving a configuration to decode the DCI in the control signal.

Embodiment F3. The method of Embodiment F1, wherein the first network node is a Primary Cell (PCell) operating within a first Frequency Range (FR1) and the second network node is Secondary Cell (SCell) operating within a second Frequency Range (FR2).

Embodiment F4. The method of Embodiment F1, further including:
receiving a retransmission of the control signal including the DCI grant and including one of a new uplink (UL) scheduling information, an elevated physical downlink control channel (PDCCH) aggregation level, and an elevated power level.

Embodiment F5. The method of Embodiment F1, further including:
receiving an indication of a DCI for downlink (DL) data scheduling for the WD to receive PDCCH with the DCI from the second network node.

Embodiment F6. The method of Embodiment F1, further including:
after an alignment time interval elapses, receiving aligned slots and resources in which the second network node transmits the DCI and the first network node one of receives the UL data on a physical uplink shared channel (PUSCH) from the WD and transmits downlink data on a physical downlink shared channel (PDSCH) to the WD.

Embodiment F7. The method of Embodiment F1, further including:
when one of the second network node and the WD is not available for the cross-carrier scheduling:
receiving increased downlink resources of one of the first network node and the second network node;
receiving a message to offload from the second network node; and
receiving a modified UL scheduling.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A first network node configured to communicate with a second network node and a wireless device, WD, the first network node comprising processing circuitry configured to:
determine a cross-carrier scheduling based at least in part on a first network load on the first network node; and
determine a signaling based on the determined cross-carrier scheduling, the signaling including a control signal transmitted at least to the WD by the second network node and uplink, UL, data transmitted by the WD to the first network node in response to the control signal.

2. The first network node of claim 1, wherein the processing circuitry is further configured to at least one of:
determine whether the WD supports the cross-carrier scheduling based on a field of a WD capability message; and
configure the WD to decode downlink control information, DCI, in the control signal transmitted by the second network node and at least one of:
decode downlink, DL, data from the first network node; and
transmit UL data.

3. The first network node of claim 1, wherein the processing circuitry is further configured to:
determine a physical downlink control channel, PDCCH, of the first network node is congested;
select the second network node for transmission of the control signal to the WD, the selection of the second network node being based at least on an inter-network delay between the first and second network nodes and a PDCCH demand of the WD; and
determine UL data requirements for communication between the WD and the first network node.

4. The first network node of claim 1, wherein the processing circuitry is further configured to at least one of:
determine an alignment time interval based on network variations and an inter-network delay; and
after the alignment time interval elapses, align slots and resources in which:
the second network node transmits the DCI; and
the first network node one of receives UL data on a PUSCH from the WD and transmits downlink data on a physical downlink shared channel, PDSCH, to the WD.

5. The first network node of claim 1, wherein the processing circuitry is further configured to, when at least one of the second network node and the WD is not available for the cross-carrier scheduling, at least one of:
increase downlink resources of one of the first network node and the second network node;
offload the second network node from other WDs to decrease a second network load on the second network node; and
modify a UL scheduling process.

6. The first network node of claim 1, wherein the processing circuitry is further configured to cause the first network node to at least one of:
transmit, to the second network node, a request to build and transmit the control signal including a DCI grant to the WD, the request including information for building the DCI grant;
receive, from the second network node, a confirmation based on the request;
receive WD data and update network load information and inter-network delay information based on the received WD data; and
transmit, to the second network node, a retransmission request when one of UL data on a physical uplink shared channel, PUSCH, is not decoded and the control signal on PDCCH is not received by the WD.

7. The first network node of claim 1, wherein the first network node is a Primary Cell, PCell, operating within a first Frequency Range, FR1, and the second network node is Secondary Cell, SCell, operating within a second Frequency Range, FR2.

8. A method implemented in a first network node configured to communicate with a second network node and a wireless device, WD, the method comprising:
determining a cross-carrier scheduling based at least in part on a first network load on the first network node; and
determining a signaling based on the determined cross-carrier scheduling, the signaling including a control signal transmitted at least to the WD by the second network node and uplink, UL, data transmitted by the WD to the first network node in response to the control signal.

9.-14. (canceled)

15. A second network node configured to communicate at least with a first network node and a wireless device, WD, the second network node comprising processing circuitry configured to cause the second network node to:
receive a signal from the first network node, the signal comprising an indication of cross-carrier scheduling of the WD; and
send a control signal to the WD, the control signal including at least one of an uplink grant for transmitting UL data to the first network node and a request to transmit a channel state information, CSI, report to the first network node.

16. The second network node of claim 15, wherein the processing circuitry is further configured to at least one of:
determine an alignment time interval based on network variations and an inter-network delay; and
after the alignment time interval elapses, align slots and resources in which:
the second network node transmits downlink control information, DCI; and
the first network node one of receives the UL data on a PUSCH from the WD and transmits downlink data on a physical downlink shared channel, PDSCH, to the WD.

17. The second network node of claim 15, wherein the processing circuitry is further configured to cause the second network node to:
receive, from the first network node, a request to build and transmit the control signal including a DCI grant to the WD, the request including information for building the DCI grant;
transmit, to the first network node, a confirmation based on the received request; and
transmit, to the WD, the control signal.

18. The second network node of claim 17 wherein the processing circuitry is further configured to cause the second network node to:
receive, from the first network node, a retransmission request associated with at least one of UL data on a physical uplink shared channel, PUSCH, not being decoded by the first network node and the control signal not being received by the WD; and
retransmit the control signal to the WD and including one of a UL scheduling information, an elevated PDCCH aggregation level, and an elevated power level.

19. The second network node of claim 18, wherein the processing circuitry is further configured to cause the second network node to:
transmit, to a third network node, the control signal including the DCI grant indicating a physical uplink shared channel, PUSCH, grant.

20. The second network node of claim 17, wherein the processing circuitry is further configured to:
after receiving the request to build and transmit the control signal, determine an amount of PDCCH resources to serve the WD based at least one of a current downlink, DL, channel conditions and a traffic load.

21. The second network node of claim 15, wherein the processing circuitry is further configured to:
determine a DCI associated with DL data scheduling, the DCI to be transmitted by the second network node to the WD.

22. The second network node of claim 15, wherein the first network node is a Primary Cell, PCell, operating within a first Frequency Range, FR1, and the second network node is Secondary Cell, SCell, operating within a second Frequency Range, FR2.

23. A method implemented in a second network node configured to communicate at least with a first network node and a wireless device, WD, the method comprising:
receiving a signal from the first network node, the signal comprising an indication of cross-carrier scheduling of the WD; and
sending a control signal to the WD, the control signal including at least one of an uplink grant for transmitting UL data to the first network node and a request to transmit a channel state information, CSI, report to the first network node.

24.-30. (canceled)

31. A wireless device, WD, configured to communicate at least with a first network node and a second network node, the first network node being a Primary Cell, PCell, operating within a first Frequency Range, FR1, and the second network node being a Secondary Cell, Scell, operating within a second Frequency Range, FR2, the WD comprising processing circuitry configured to cause the WD to:
receive a control signal transmitted by the second network node; and
transmit WD data including uplink, UL, data to the first network node in response to the received control signal.

32. The WD of claim 31, wherein the control signal includes a downlink control information, DCI, grant for the UL data to be transmitted to the first network node.

33. The WD of claim 31, wherein the processing circuitry is further configured to cause the WD to:
transmit a message indicating the WD supports communication with the first network node and the second network node using cross-carrier scheduling.

34. The WD of claim 31, wherein the processing circuitry is further configured to cause the WD to:
after an alignment time interval elapses, receive aligned slots and resources in which the second network node transmits the DCI and the first network node one of receives the UL data on a physical uplink shared channel, PUSCH, from the WD and transmits downlink data on a physical downlink shared channel, PDSCH, to the WD.

35. The WD of claim 32, wherein the processing circuitry is further configured to cause the WD to:
receive a retransmission of the control signal from the second network node, the retransmission including the DCI grant and including one of a new uplink, UL, scheduling information, an elevated physical downlink control channel, PDCCH, aggregation level, and an elevated power level.

36. The WD of claim 31, wherein processing circuitry is further configured to cause the WD to, when one of the second network node and the WD is not available for cross-carrier scheduling, at least one of:
receive increased downlink resources of one of the first network node and the second network node;
receive an offload message to offload from the second network node; and
receive a modified UL scheduling.

37. A method implemented in a wireless device, WD, configured to communicate at least with a first network node and a second network node, the first network node being a Primary Cell, PCell, operating within a first Frequency Range, FR1, and the second network node being a Secondary Cell, Scell, operating within a second Frequency Range, FR2, the method comprising:
receiving a control signal transmitted by the second network node; and
transmitting WD data including uplink, UL, data to the first network node in response to the received control signal.

38.-42. (canceled)
